(19) United States
(12) Patent Application Publication
(10) Pub. No.: US 2023/0349589 A1
(43) Pub. Date: Nov. 2, 2023

(54) HOLE PLUG FOR HVAC COMPONENT

(71) Applicant: Carrier Corporation, Palm Beach Gardens, FL (US)

(72) Inventors: Paul Haydock, Zionsville, IN (US); James Mitchum, New Palestine, IN (US)

(21) Appl. No.: 18/194,837

(22) Filed: Apr. 3, 2023

Related U.S. Application Data
(60) Provisional application No. 63/336,406, filed on Apr. 29, 2022.

(51) Int. Cl. F24F 13/20; F16J 15/02

(52) U.S. Cl. CPC F24F 13/20; F16J 15/02

(57) ABSTRACT

A removable plug for a heating ventilation and air conditioning (HVAC) system includes a main body extending from a plug central axis, and a plug lip defining an outer perimeter of the plug. A radially outer surface is located between the main body and the plug lip. One or more plug retention features extend radially outwardly from the radially outer surface. The one or more plug retention features define an interference fit with a jacket opening of the HVAC system when the plug is installed to the jacket opening.

### CROSS-REFERENCE TO RELATED APPLICATIONS

This application claims the benefit of U.S. Provisional Application No. 63/336,406 filed Apr. 29, 2022, the disclosure of which is incorporated herein by reference in its entirety.

### BACKGROUND

Exemplary embodiments pertain to the art of heating, ventilation and air conditioning (HVAC) systems.

HVAC systems, such as, for example, air handlers or furnaces, include components contained in an outer jacket or casing. It is necessary to provide access through the jacket for connections such as vent and combustion air piping, electrical power and controls, condensate trap, and other auxiliary component connections. The jacket provides resistance to air leakage, as air leakage reduces efficiency of the HVAC system or may affect combustion performance. Such access is typically provided by knockout features provided in various locations in the jacket. Such knockout features (often referred to as ‘slugs’) that are formed as removable segments in the jacket, however, are not replaceable into the jacket once removed, and thus result in significant air leakage in the event that a component connection is no longer needed, or a connection routing is changed so the knockout is no longer needed.

### BRIEF DESCRIPTION

In one embodiment, a removable plug for a heating ventilation and air conditioning (HVAC) system includes a main body extending from a plug central axis, and a plug lip defining an outer perimeter of the plug. A radially outer surface is located between the main body and the plug lip. One or more plug retention features extend radially outwardly from the radially outer surface. The one or more plug retention features define an interference fit with a jacket opening of the HVAC system when the plug is installed to the jacket opening.

Additionally or alternatively, in this or other embodiments the plug is formed from a metal material.

Additionally or alternatively, in this or other embodiments a plug recess connects the main body to the plug lip. The plug recess includes the radially outer surface extending from the plug lip, a radially inner surface extending from the main body, and a recess base connecting the radially inner surface and the radially outer surface. The recess base is offset from the main body in an axial direction relative to the plug central axis.

Additionally or alternatively, in this or other embodiments each of the radially inner surface and the radially outer surface extend at a non-zero angle relative to the plug central axis.

Additionally or alternatively, in this or other embodiments an inner surface angle of the radially inner surface is in the range of 10-20 degrees.

Additionally or alternatively, in this or other embodiments an outer surface angle of the radially outer surface is in the range of 2-5 degrees.

Additionally or alternatively, in this or other embodiments the plug lip extends radially outwardly at a lip angle relative to the main body in the range of 5 to 10 degrees.

Additionally or alternatively, in this or other embodiments the plug is one of circular, oval, rectangular or rounded rectangular in shape.

Additionally or alternatively, in this or other embodiments the one or more plug retention features are one or more dimples.

Additionally or alternatively, in this or other embodiments a dimple of the one or more dimples has a curvilinear cross-sectional shape.

Additionally or alternatively, in this or other embodiments the main body is axially offset from the plug lip relative to the plug central axis.

Additionally or alternatively, in this or other embodiments the one or more plug retention features are one or more fasteners installed through the radially outer surface.

In another embodiment, a heating, ventilation and air conditioning (HVAC) system includes one or more HVAC system components, and a jacket enclosing the one or more HVAC system components. The jacket includes a jacket outer surface, one or more jacket openings formed in the jacket outer surface, and a removable plug installed in a jacket opening of the one or more jacket openings. The plug includes a main body extending from a plug central axis, a plug lip defining an outer perimeter of the plug, a radially outer surface disposed between the main body and the plug lip, and one or more plug retention features extending radially outwardly from the radially outer surface. The one or more retention features define an interference fit with a jacket opening of the HVAC system when the plug is installed to the jacket opening.

Additionally or alternatively, in this or other embodiments the plug is formed from a metal material.

Additionally or alternatively, in this or other embodiments a plug recess connects the main body to the plug lip. The plug recess includes the radially outer surface extending from the plug lip, a radially inner surface extending from the main body, and a recess base connecting the radially inner surface and the radially outer surface. The recess base is offset from the main body in an axial direction relative to the plug central axis.

Additionally or alternatively, in this or other embodiments each of the radially inner surface and the radially outer surface extend at a non-zero angle relative to the plug central axis.

Additionally or alternatively, in this or other embodiments the plug lip extends radially outwardly at a lip angle relative to the main body in the range of 5 to 10 degrees.

Additionally or alternatively, in this or other embodiments the one or more plug retention features are one or more dimples.

Additionally or alternatively, in this or other embodiments the main body is axially offset from the plug lip relative to the plug central axis.

Additionally or alternatively, in this or other embodiments the one or more plug retention features are one or more fasteners installed through the radially outer surface.

### BRIEF DESCRIPTION OF THE DRAWINGS

The following descriptions should not be considered limiting in any way. With reference to the accompanying drawings, like elements are numbered alike:

FIG. 1 is a perspective view of an exemplary heating, ventilation, and air conditioning (HVAC) system jacket in accordance with various aspects of the disclosure;

FIG. 2 is a plan view of an embodiment of a removable plug of an HVAC system jacket in accordance with various aspects of the disclosure;

FIG. 3 is a cross-sectional view of an embodiment of a removable plug of an HVAC system jacket in accordance with various aspects of the disclosure;

FIG. 4 is another cross-sectional view of an embodiment of a removable plug of an HVAC system jacket in accordance with various aspects of the disclosure; and

FIG. 5 is a cross-sectional view of another embodiment of a removable plug of an HVAC system in accordance with various aspects of the disclosure.

### DETAILED DESCRIPTION

A detailed description of one or more embodiments of the disclosed apparatus and method are presented herein by way of exemplification and not limitation with reference to the Figures.

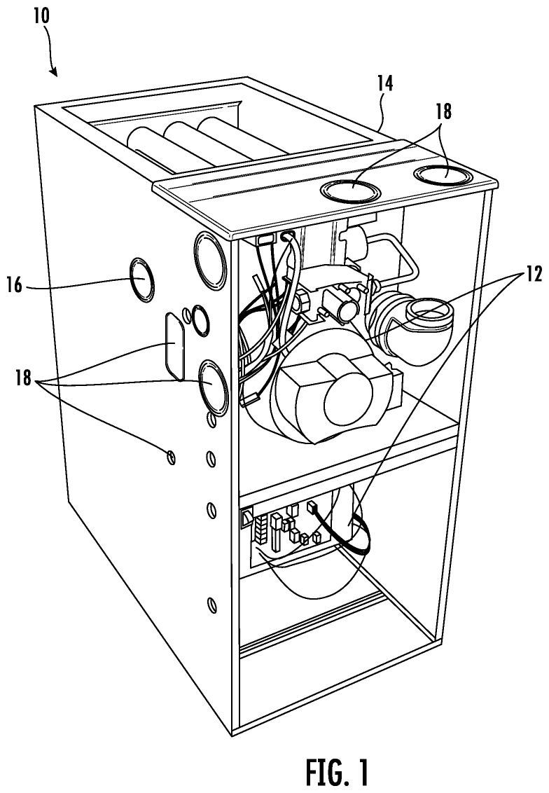

Referring now to FIG. 1, illustrated is an embodiment of a furnace 10, which includes one or more furnace components 12, such as a burner, fan or the like, disposed in a housing or jacket 14. One or more jacket openings 16 (shown in FIG. 4) are formed in the jacket 14, which allow for access to the one or more furnace components 12 located inside the jacket 14, and allow for connections to be made between the one or more furnace components 12 inside the jacket 14 and additional components which may be located outside of the jacket 14. It should be appreciated that although described here as a furnace 10, the jacket 14 may be a jacket 14 for any suitable heating, ventilation, and air conditioning system.

While a plurality of such jacket openings 16 are formed in the jacket 14, not all of the jacket openings 16 may be utilized at any one time, depending on factors such as an orientation of the furnace 10 and jacket 14 at an installation site, components connected to the furnace 10 and access locations needed into the jacket 14 for a particular furnace 10 installation and configuration. It should be appreciated that a single jacket 14 may be utilized for multiple furnace configurations.

Plugs 18 are installed to the unused jacket openings 16 of the jacket 14. The plugs 18 are formed from a heat resistant material (e.g., metal, etc.) and are configured to resist deformation and warpage. The plugs 18 are fitted to the jacket openings 16 so the plugs 18 may be retained in place for an entire service life of the furnace 10, for example, twenty (20) years or more, and for transport of the furnace 10 to the installation location. The plugs 18 are configured to be easy to remove from and install to the jacket 14, fit closely to the jacket openings 16 to resist air leakage through the jacket 14, and are relatively low cost. The plugs 18 are configured to be installed in a variety of jacket opening 16 sizes and shapes. For example, some plugs 18, may be installed in a circular jacket opening 16 (e.g., which may have a 3 inch diameter. It should be appreciated that the plugs 18 may be configured to fit any jacket opening 16, such as, for example, 1.75 inch diameter, 0.875 inch diameter, 0.75 inch diameter or 0.50 inch diameter jacket openings 16. Further, the plugs 18 may be shaped and sized to be installed in rectangular jacket openings 16 and/or jacket openings 16 which are rectangular with rounded corners. For example, in one embodiment the plug 18 is configured for installation into a rectangular opening which is 4 inches by 2.5 inches and having rounded corners. It should be appreciated that the plugs 18 may be configured to fit any jacket opening 16 with any associated geometry.

In some embodiments, the jacket 14 is formed from a metal material, such as sheet steel which may be in the range of 0.03 to 0.035 inches thick. The plugs 18 may be formed from the same material, or alternatively from a different metal material than the jacket 14. For example, in some embodiments the plugs 18 may be formed from an aluminum material or other metal material having a thickness in the range of 0.016 to 0.020 inches. One skilled in the art, however, will readily appreciate that the plugs 18 may be formed having other material thicknesses.

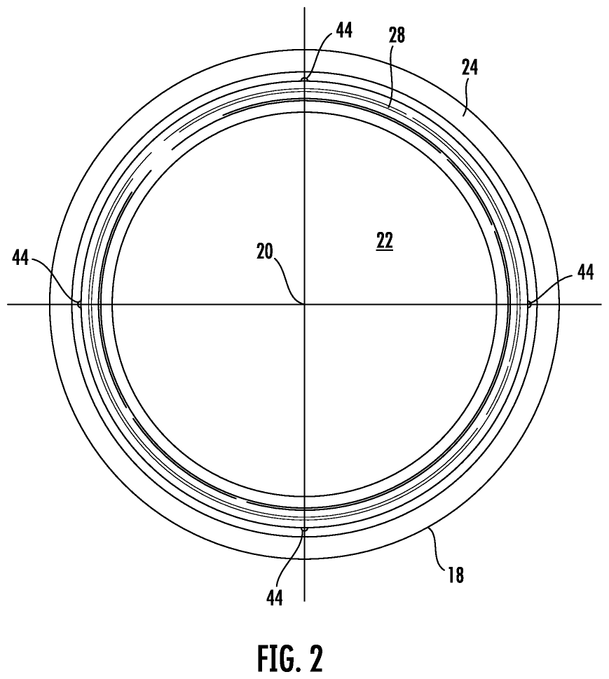

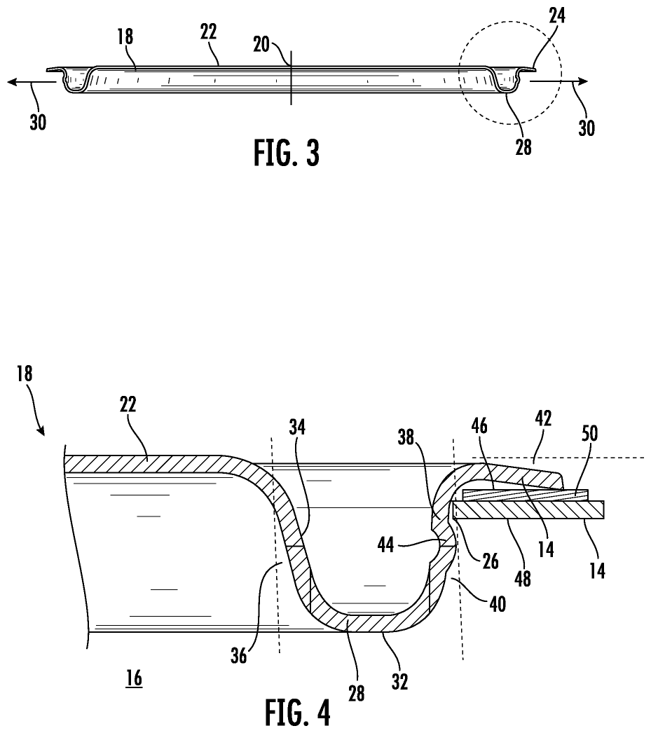

Referring now to FIGS. 2, 3, and 4, illustrated are an embodiment of a plug 18. In the illustrated embodiment, the plug 18 is circular having a central axis 20 and configured to be installed into a circular jacket opening 16, but one skilled in the art will readily appreciate that the plug 18 may have a different shape depending on the shape of the jacket opening 16 into which the plug 18 is installed, such as oval, rectangular, or rounded rectangular. Referring to the cross-sectional view of FIG. 3, the plug 18 generally includes a main body 22 located at the central axis 20. A plug lip 24 is located at an outer perimeter of the plug 18 and overlaps an opening edge 26 (shown in FIG. 4) of the jacket opening 16. A plug recess 28 is located between the plug lip 24 and the main body 22. When the plug is installed to the jacket opening 16, the plug recess 28 is configured to exert a radially outward retention force 30 in the opening edge 26 to retain the plug 18 in an installed position in the jacket opening 16.

The plug recess 28 is illustrated in more detail in the partial cross-sectional view of FIG. 4. The plug recess 28 includes a recess base 32, which defines a bottommost portion of the plug recess 28. In some embodiments the recess base 32 is flat and planar. An inner sloping portion 34 of the plug recess 28 connects the main body 22 to the recess base 32. The inner sloping portion 34 extends toward the recess base 32 at a non-zero inner angle 36 relative to the central axis 20. In some embodiments, the inner angle 36 is in the range of ten (10) degrees to twenty (20) degrees. Similarly, an outer sloping portion 38 of the plug recess 28 connects the plug lip 24 to the recess base 32. The outer sloping portion 38 extends toward the recess base 32 at a non-zero outer angle 40 relative to the central axis 20. In some embodiments, the outer angle 40 is in the range of two (2) degrees to five (5) degrees. The inner angle 36 and the outer angle 40 may be modified or tuned to achieve a desired insertion or retention force of the plug 18 in the plug opening 16. In some embodiments, the plug lip 24 is set at a lip angle 42 relative to the flat planar main body 22. In some embodiments, the lip angle 42 is in the range of five (5) degrees to ten (10) degrees.

The plug 18 includes one or more dimples 44 formed in the plug 18, and located on the outer sloping portion 38. The dimple 44 extends radially outwardly from the outer sloping portion 38, and when the plug 18 is installed to the jacket 14, while the plug lip 24 abuts an outer jacket surface 46 define on an outside of the jacket 14, the dimple 44 engages an inner jacket surface 48 on an inside of the jacket 14. In some embodiments, the dimple 44 is curvilinear in shape. The dimple 44 aids in retention of the plug 18 in the jacket opening 16. The size, number, and location of the dimples 44 may vary depending on the size and shape of the jacket opening 16 and plug 18, and may also be varied based on the retention properties desired. For example, as shown in FIG. 2, four dimples 44 are utilized and are equally spaced around the plug 18. In other embodiments, other quantities of dimples 44, such as two, three, five or more dimples 44 may be used. Further, the circumferential spacing of the dimples 44 may be varied around the plug 18. In some embodiments, to provide additional sealing performance, a sealing element 50, such as a paper, plastic, rubberized sealant, wax, or a combination thereof, may be installed between the plug lip 24 and the outer jacket surface 46.

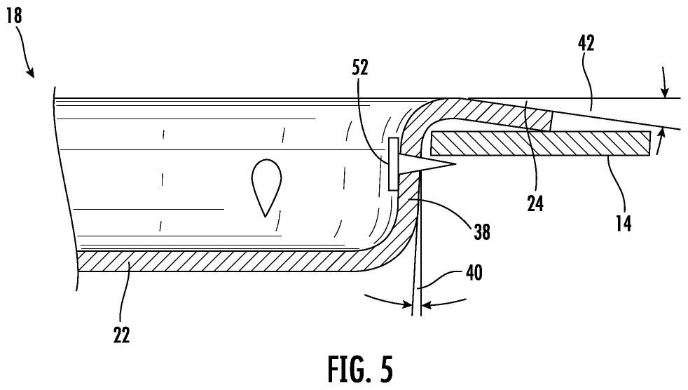

In another embodiment, illustrated in FIG. 5, the entire plug main body 22 is recessed relative to the plug lip 24, and extends to the outer sloping portion 38, such that the main body 22 of the plug 18 is flat and planar up to the outer sloping portion 38. Such a configuration may be used, for example, in plugs 18 which are less than 1.75 inches in diameter. To aid in retaining the plug 18 in the jacket opening 16, some embodiments may include one or more fasteners such as a screw 52 installed through the plug 18 at, for example, the outer sloping portion 38, and into the interior of the jacket 14. This prevents the plug 18 from being removed from the jacket opening 16 while the screw 52 is installed. It should be appreciated that the screw 52 may be any suitable fastener that requires a tool to remove.

The plug 18 configurations disclosed herein are easy to install and improve leakage performance of the jacket 14 due to tight and leak-resistant fit and retention of the plug 18 to the jacket openings 16. Further, the metal construction improves heat resistance of the plugs 18, and prevents warpage, melting or burning of the plug.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A removable plug for a heating, ventilation, and air conditioning (HVAC) system, comprising:
a main body extending from a plug central axis;
a plug lip defining an outer perimeter of the plug;
a radially outer surface disposed between the main body and the plug lip; and
one or more plug retention features extending radially outwardly from the radially outer surface, the one or more retention features defining an interference fit with a jacket opening of the HVAC system when the plug is installed to the jacket opening.

2. The plug of claim 1, wherein the plug is formed from a metal material.

3. The plug of claim 1, further comprising a plug recess connecting the main body to the plug lip, the plug recess comprising:
the radially outer surface extending from the plug lip;
a radially inner surface extending from the main body; and
a recess base connecting the radially inner surface and the radially outer surface, the recess base offset from the main body in an axial direction relative to the plug central axis.

4. The plug of claim 3, wherein each of the radially inner surface and the radially outer surface extend at a non-zero angle relative to the plug central axis.

5. The plug of claim 4, wherein an inner surface angle of the radially inner surface is in the range of ten (10) to twenty (20) degrees.

6. The plug of claim 4, wherein an outer surface angle of the radially outer surface is in the range of two (2) to five (5) degrees.

7. The plug of claim 1, wherein the plug lip extends radially outwardly at a lip angle relative to the main body in the range of five (5) to ten (10) degrees.

8. The plug of claim 1, wherein the plug is one of circular, oval, rectangular, or rounded rectangular in shape.

9. The plug of claim 1, wherein the one or more plug retention features are one or more dimples.

10. The plug of claim 1, wherein each respective dimple of the one or more dimples comprises a curvilinear cross-sectional shape.

11. The plug of claim 1, wherein the main body is axially offset from the plug lip relative to the plug central axis.

12. The plug of claim 1, wherein the one or more plug retention features are one or more fasteners installed through the radially outer surface.

13. A heating, ventilation, and air conditioning (HVAC) system, comprising:
one or more HVAC system components; and
a jacket enclosing the one or more HVAC system components, the jacket comprising:
a jacket outer surface;
one or more jacket openings formed in the jacket outer surface; and
a removable plug installed in a jacket opening of the one or more jacket openings, the plug comprising:
a main body extending from a plug central axis;
a plug lip defining an outer perimeter of the plug;
a radially outer surface disposed between the main body and the plug lip; and
one or more plug retention features extending radially outwardly from the radially outer surface, the one or more retention features defining an interference fit with a jacket opening of the HVAC system when the plug is installed to the jacket opening.

14. The HVAC system of claim 13, wherein the plug is formed from a metal material.

15. The HVAC system of claim 13, further comprising a plug recess connecting the main body to the plug lip, the plug recess comprising:
the radially outer surface extending from the plug lip;
a radially inner surface extending from the main body; and
a recess base connecting the radially inner surface and the radially outer surface, the recess base offset from the main body in an axial direction relative to the plug central axis.

16. The HVAC system of claim 15, wherein each of the radially inner surface and the radially outer surface extend at a non-zero angle relative to the plug central axis.

17. The HVAC system of claim 13, wherein the plug lip extends radially outwardly at a lip angle relative to the main body in the range of five (5) to ten (10) degrees.

18. The HVAC system of claim 11, wherein the one or more plug retention features are one or more dimples.

19. The HVAC system of claim 13, wherein the main body is axially offset from the plug lip relative to the plug central axis.

20. The HVAC system of claim 13, wherein the one or more plug retention features are one or more fasteners installed through the radially outer surface.
